(19) United States
(12) Patent Application Publication
(10) Pub. No.: US 2018/0349153 A1
(43) Pub. Date: Dec. 6, 2018

(54) MIGRATION BETWEEN DIFFERENT USER INTERFACES OF SOFTWARE PROGRAMS

(71) Applicant: International Business Machines Corporation, Armonk, NY (US)

(72) Inventors: Francesco Brillante, Scafati (IT); Luca Lazzaro, Naples (IT); Alessandro Scotti, Roma (IT)

(21) Appl. No.: 15/614,796

(22) Filed: Jun. 6, 2017

(51) Int. Cl. G06F 9/44; G09B 19/00; G09B 5/06; G06F 3/0481

(52) U.S. Cl. CPC G06F 9/4446; G06F 3/0481; G09B 5/065; G09B 19/0053

(57) ABSTRACT

A method, computer system, and computer program product for facilitating usage of a software program on a computing system is provided. A method includes receiving a learning request in the new user interface, displaying a simulation of an old user interface of the software program, the simulation of the old user interface exposing one or more old commands for requesting the execution of tasks, receiving a submission of one or more selected old commands of old commands in the simulation of the old user interface for requesting the execution of a selected task, identifying a selected tutorial for the selected task among corresponding tutorials for the tasks, each tutorial comprising an indication of one or more selected new commands of new commands for requesting the execution of the corresponding task in the new user interface, and outputting a representation of the selected tutorial.

### TECHNICAL FIELD

The present disclosure relates to the information technology field, and more specifically, this disclosure relates to user interfaces of software programs.

### BACKGROUND

Any software program requiring interactions with human users exposes a corresponding User Interface (UI); particularly, the user interface allows the human users to control operation of the software program by inputting commands and to receive any feedback from the software program by outputting information. A typical example is a Graphical User Interface (GUI), wherein the users interact with the software program by means of visual objects, or interactors (e.g. buttons, menus), which are displayed and manipulated on a monitor.

Generally, any software program, comprising a user interface, continuously changes over time. Particularly, the user interface adapts to the different functionalities of the software program; moreover, the user interface may evolve for improving usability and user experience, modernizing a look and feel, and applying different interaction paradigms. Nowadays, the changes to the user interfaces occur very often, especially in case the software program is for use on mobile devices.

### SUMMARY

A method, computer system, and computer program product for facilitating usage of a software program on a computing system is provided. A processor of a computing system receives a learning request in the new user interface. A simulation of an old user interface of the software program is displayed in response to the learning request, the simulation of the old user interface exposing one or more old commands for requesting the execution of the one or more tasks. A submission of one or more selected old commands of the one or more old commands in the simulation of the old user interface is received for requesting the execution of a selected task of the one or more tasks. A selected tutorial for the selected task is selected among one or more corresponding tutorials for the one or more tasks in response to the submission of the selected old commands, each tutorial comprising an indication of one or more selected new commands of the one or more new commands for requesting the execution of the corresponding task in the new user interface. A representation of the selected tutorial is outputted.

### BRIEF DESCRIPTION OF THE DRAWINGS

FIG. 1A is a block diagram of a computing system, wherein a user is requesting a task to be performed, in accordance with embodiments of the present invention.

FIG. 1B is a block diagram of a computing system, wherein the user is submitting an old command in a simulation, in accordance with embodiments of the present invention.

FIG. 1C is a block diagram of a computing system, wherein a selected tutorial is identified, in accordance with embodiments of the present invention.

FIG. 1D is a block diagram of a computing system, wherein a tutorial is outputted to a user computer, in accordance with embodiments of the present invention.

FIG. 2 is a block diagram of a computing system for implementing a method for facilitating usage of a software program on a computing system, in accordance with embodiments of the present invention.

FIG. 3 is a block diagram of main software components of the computing system of FIG. 2, in accordance with embodiments of the present invention.

FIG. 4A is a block diagram of a scenario of an old interface and new interface of a software program, in accordance with embodiments of the present invention.

FIG. 4B is a block diagram of a simulation of the old interface and tutorials, in accordance with embodiments of the present invention.

FIG. 5A is a first part of a flowchart of a method for building a software program in a test environment, in accordance with embodiments of the present invention.

FIG. 5B is a second part of a flowchart of a method for building a software program in a test environment, in accordance with embodiments of the present invention.

FIG. 5C is a flowchart of a method for learning a new user interface of the software program in a production environment, in accordance with embodiments of the present invention.

### DETAILED DESCRIPTION

Every migration between different versions of the user interface (i.e., from an old user interface to a new user interface) may be challenging for the users. Indeed, major changes may have been applied to the user interface; for example, many interactors may have been renamed, updated, moved, reorganized. In this case, the use of the new user interface may be quite frustrating, a typical example is when the users are not able to find in the new user interface how to perform a task that they were familiar to perform differently in the old user interface.

Several techniques have been proposed in an attempt to facilitate the learning of the user interfaces.

For example, most software programs are delivered with a corresponding user manual; training material (e.g., in the form of interactive tutorials) and teaching classes may also be available. However, the learning of any user interface in this way is very time consuming and completely separate from the actual use of the software program.

The use of a transparency skin has also been proposed, wherein the old user interface is overlaid over the new user interface with at least a portion of the old user interface that is semi-transparent so as to leave the new user interface visible); when an input is directed to the old user interface a corresponding control in the new user interface is highlighted to indicate how to initiate the corresponding operation using the new interface. However, the overlay is difficult to use, and may be ineffective in case of significant changes e.g., when interactors are moved to different panels).

Moreover, each software program is generally provided with an online help that may be requested during the use of the software program in case of necessity; particularly, the online help may also comprise tutorials, for example, in graphical form being overlaid over the user interface so as to instruct the users how to provide pertinent inputs. However, the identification of information relating to any task the users are trying to perform is generally relatively complex, tedious and slow.

Therefore, an initial learning curve of any new user interface is quite steep, which adversely affects the usage of the software program, and then a productivity level of the users, until the users become sufficiently familiar with the new user interface.

Moreover, the production and maintenance of any tool aimed at facilitating the learning of the user interfaces is very time consuming. Particularly, recognizing in advance any specific needs of the users before each new user interface is released can be difficult, because the specific needs are tied individually to the personal habits of each user.

In general terms, the present disclosure is based on the idea of using a simulation of the old user interface to identify tutorials of the new user interface.

Particularly, an aspect provides a method for facilitating usage of a software program, wherein in response to a learning request in a new user interface of the software program a simulation is displayed of an old user interface thereof, a submission is received of one or more selected old commands in the simulation of the old user interface for requesting the execution of a selected task, and a representation is output of a selected tutorial for requesting the execution of the selected task in the new user interface.

A further aspect provides a computer program for implementing this method. A further aspect provides a corresponding computer program product. A further aspect provides a corresponding system.

A further aspect provides a method for building a computer program, wherein an old test is run of the software program having the old user interface, old representations of the old user interface are captured and added to the simulation of the old user interface in correspondence to old verifications of the old test, a new test is run of the software program having the new user interface and the tutorials are built for the new user interface from the new test in correspondence to new verifications thereof. A further aspect provides a computer program for implementing this method. A further aspect provides a corresponding computer program product. A further aspect provides a corresponding system.

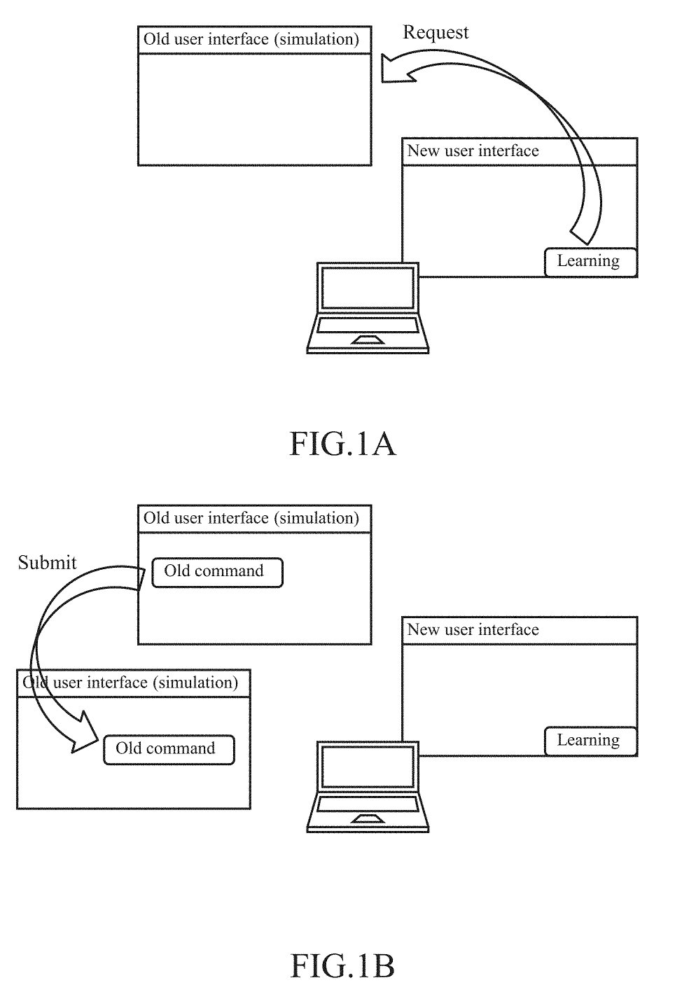

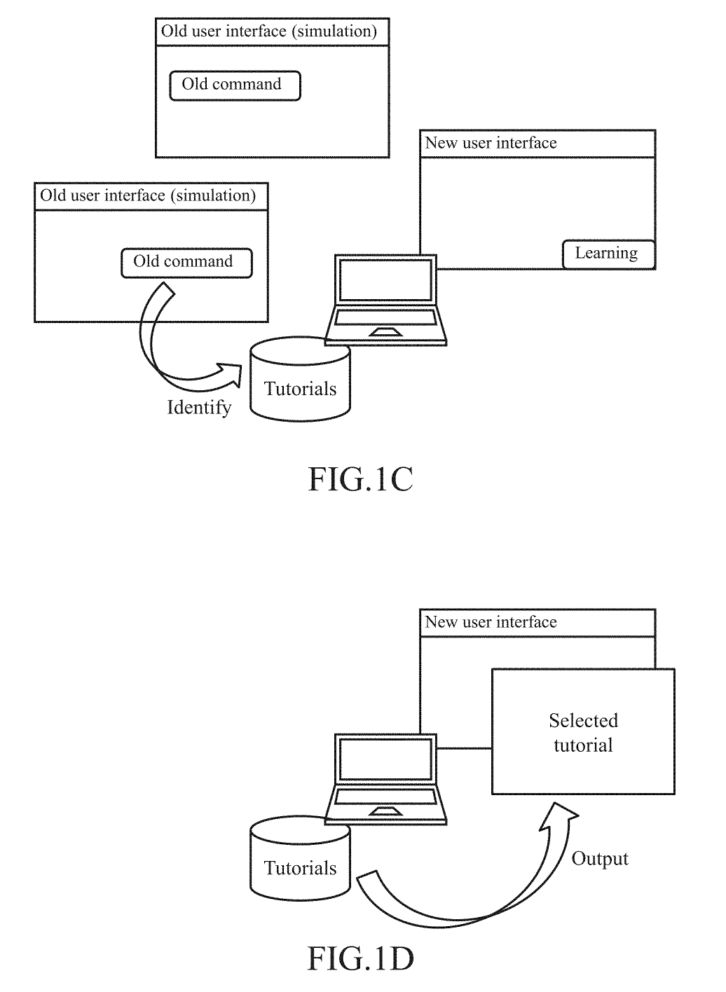

With reference in particular to FIGS. 1A-FIG. 1D, the general principles are shown of the solution according to an embodiment of the present disclosure.

FIG. 1A is a block diagram of a computing system, wherein a user is requesting a task to be performed, in accordance with embodiments of the present invention. Starting from FIG. 1A, a software program is running on a computing system (e.g., a personal computer). The software program is interactive, i.e., the software program accepts inputs from human users during running; for this purpose, the software program has a new user interface (e.g. a GUI), which allows each human user of the software program to interact (e.g. dialog) with the software program. Particularly, the new user interface exposes one or more new commands (e.g., buttons, menus); the new commands allow the user to request the execution of one or more tasks to the software program (e.g., creating a table, sorting a list). In an exemplary embodiment, a further command (e.g., a dedicated button) is provided for allowing the user to submit a learning request of the new user interface. In response thereto, a simulation of a previous version of the user interface (i.e. old user interface) is displayed, the old user interface exposes one or more old commands that allow the user to request the execution of the same tasks.

FIG. 1B is a block diagram of a computing system, wherein the user is submitting an old command in a simulation, in accordance with embodiments of the present invention. For instance, FIG. 1B depicts a user submitting one or more selected old commands in the simulation of the old user interface; the selected old commands are for requesting the execution of a specific selected task, which the user knows how to perform in the old user interface but not in the new user interface.

FIG. 1C is a block diagram of a computing system, wherein a selected tutorial is identified, in accordance with embodiments of the present invention. For instance, in FIG. 1C, a selected tutorial for the selected task is identified among one or more tutorials that are available for the tasks (e.g., stored in the personal computer); each tutorial explains how to request the execution of the corresponding task in the new user interface, i.e., the tutorial indicates one or more selected new commands to be used for this purpose.

FIG. 1D is a block diagram of a computing system, wherein a tutorial is outputted to a user computer, in accordance with embodiments of the present invention. For instance, in FIG. 1D, a representation of the selected tutorial is output on the personal computer (e.g., by displaying in succession the new selected commands with corresponding instructions).

The above-described solution significantly facilitates the learning of the new user interface.

Indeed, any learning request may be submitted online during the actual use of the software program whenever it is necessary without substantially affecting the new user interface apart from the addition of the corresponding command; however, in this case, the identification of the information relating to the task the user is trying to perform is very simple, because the selected tutorial is identified automatically simply by submitting the corresponding old commands in the simulation of the old user interface. Therefore, the user may learn how to perform any task in the new user interface according to the way the user is familiar to perform the task in the old user interface, in this way, the learning of the new user interface self-adapts individually to the personal habits of the user.

All of the above improves an initial learning curve of the new user interface, which has a beneficial effect on the usage of the software program, and then on a productivity level of the user who may become sufficiently familiar with the new user interface very fast.

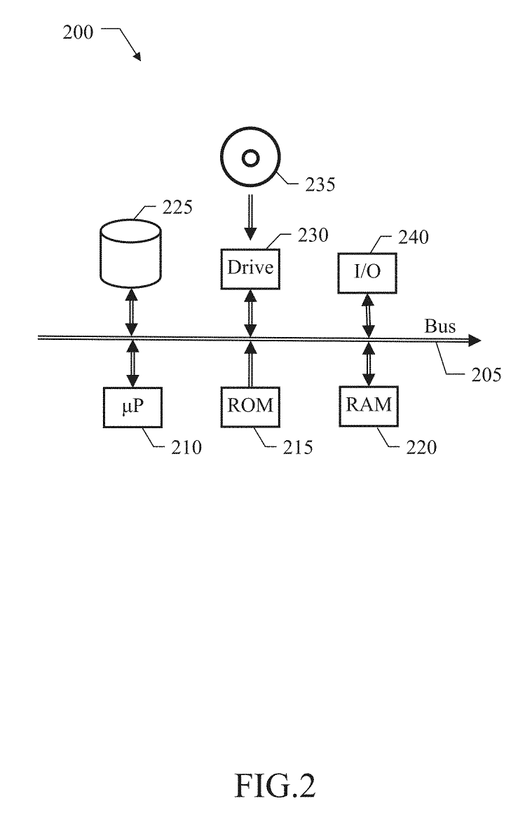

With reference now to FIG. 2, which is a block diagram of a computing system for implementing a method for facilitating usage of a software program on a computing system, in accordance with embodiments of the present invention. For instance, FIG. 2 depicts a schematic block diagram of a computing system 200 For example, the computing system 200 is a Personal Computer (PC), or simply a computer. The computer 200 comprises several units that are connected among them through a bus structure 205. Particularly, one or more microprocessors (μP) 210 control operation of the computer 200; a non-volatile memory (ROM) 215 stores basic code for a bootstrap of the computer 200 and a volatile memory (RAM) 220 is used as a working memory by the microprocessors 210. The computer 200 is provided with a mass-memory for storing programs and data, for example, comprising a hard disk 225 and a drive 230 for reading/writing removable storage units 235 (e.g. DVDs). Moreover, the computer 200 comprises a number of peripheral, or Input/Output (I/O), units 240; for example, the peripheral units 240 comprise a keyboard and a mouse for inputting commands and data, a monitor for displaying information and a network interface for connecting the computer 200 to a communication network, for example, the Internet.

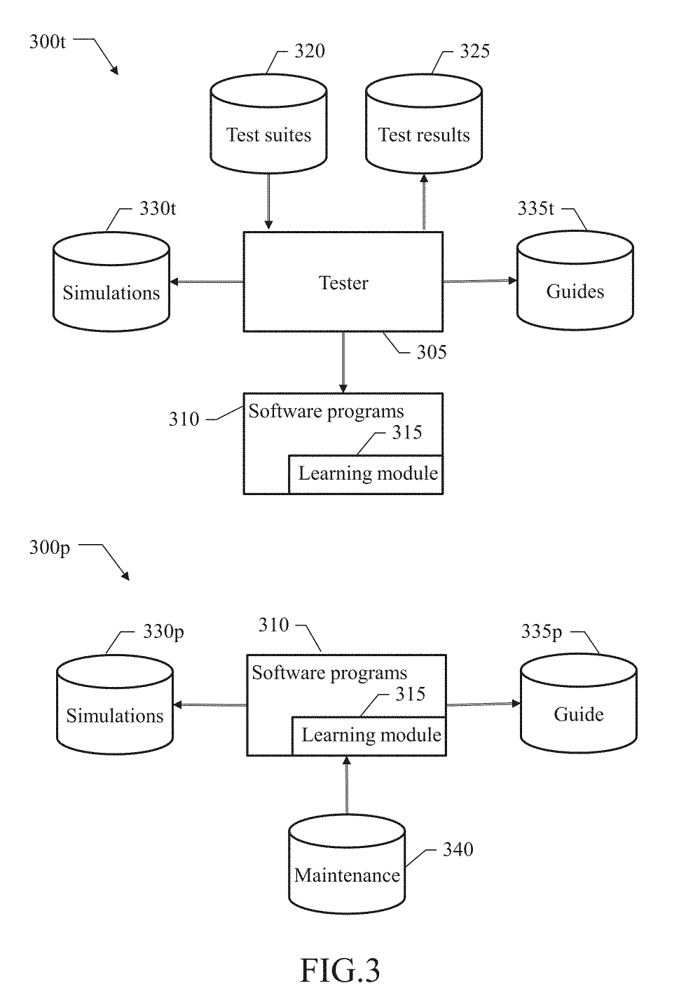

FIG. 3 is a block diagram of main software components of the computing system of FIG. 2, in accordance with embodiments of the present invention. The main software components shown may be used to implement the solution according to an exemplary embodiment of the present disclosure.

All the software components (i.e. programs and data) are typically stored in the mass memory and loaded at least partially into the working memory of the above-described computer when the programs are running, together with an operating system and other application programs (not shown in FIG. 3). The programs are initially installed into the mass memory, for example, from the removable storage units or from the communication network. In this respect, each program may be a module, segment or portion of code, which comprises one or more executable instructions for implementing the specified logical function.

Particularly, when the computer is used in a test environment the following software components, denoted as a whole with the reference 300t, are installed thereon.

A tester 305 is used to test one or more software programs automatically, comprising interactive software programs 310 (e.g., end-user application programs). In the solution according to an exemplary embodiment of the present disclosure, each interactive software program 310 comprises a learning module 315 (e.g., a corresponding plug-in) that is used to implement the above-mentioned solution for facilitating the learning of the software program's user interface. The tester 305 accesses (e.g. in read mode) a test suite repository 320, which stores corresponding test suites for the software programs 310 to be tested. The test suite of each software program 310 comprises one or more test cases, each one for verifying a corresponding use case, i.e., a scenario representing an interaction with the software program 310 for accomplishing a specific goal that is implemented by a corresponding task executed by the software program 310. In turn, each test case comprises one or more test steps, each one defined by an action (i.e., an input to be provided to the software program 310 comprising one or more commands to be submitted thereto possibly with the entering of corresponding input data) optionally followed by a verification of an outcome; in any case, the test case ends with a verification of the execution of the corresponding task. Moreover, the tester 305 accesses (e.g. in write mode) a test result repository 325, which stores corresponding test results of the test suites that have been run on the software programs 310; the test result of each test suite indicates a result (e.g. passed or failed) of each verification of the test cases (e.g. always comprising the one of the task), together with information relating to each failure (e.g., wrong outcome not matching the expected one, crash or endless loop of the software program 310).

In an exemplary embodiment of the present disclosure, the tester 305 accesses (e.g. in write mode) a global simulation repository 330t, which stores corresponding simulations of the user interfaces of the software programs 310. The simulation of each user interface comprises one or more panel representations of the user interface's panels. For each panel, identified by a corresponding (e.g. unique) panel identifier, the panel representation comprises a screenshot thereof with an indication of one or more commands that may be submitted in the panel (e.g., a type, position and possible input fields for entering input data); each command is associated with a corresponding handler, which indicates another panel to be displayed (i.e., its panel identifier) or the task to be executed by the software program 310 identified by a corresponding unique task identifier in response to the submission of the command, possibly according to input data. Moreover, the tester 305 accesses (e.g. in write more) a global guide repository 335t, which stores corresponding guides of the user interfaces of the software programs 310. The guide of each user interface comprises one or more tutorials for corresponding tasks to be executed by the software program 310; each tutorial comprises an explanation for each panel of the user interface wherein any actions may be performed to request the execution of the task to the software program 310 (e.g., a wizard comprising a screenshot of the panel accompanied by instructions for the commands).

On the other hand, when the computer is used in a production environment the following software components, denoted as a whole with the reference 300p, are installed thereon.

One or more of the software programs 310 with their learning modules 315 are available for their usage to a user or more of the computer. In an exemplary embodiment of the present disclosure, the learning module 315 of each software program 310 accesses (e.g. in read mode) a local simulation repository 330p, which stores the simulations of any old user interfaces of the software program 310 that have been installed on the computer in the past. Moreover, the learning module 315 accesses (e.g. in read mode) a local guide repositories 335p, which stores the guide (i.e., its tutorials) of the new user interface of the software program 310 that is currently installed on the computer. The learning module 315 further accesses (e.g. in read mode) a maintenance registry 340, which stores information relating to any maintenance operations that have been performed on the computer (e.g., controlled by the computer's operating system); as far as relevant to the present disclosure, the maintenance registry 345 comprises an indication of any versions of the software programs 310 and then of the software program's old user interfaces that have been installed on the computer over time.

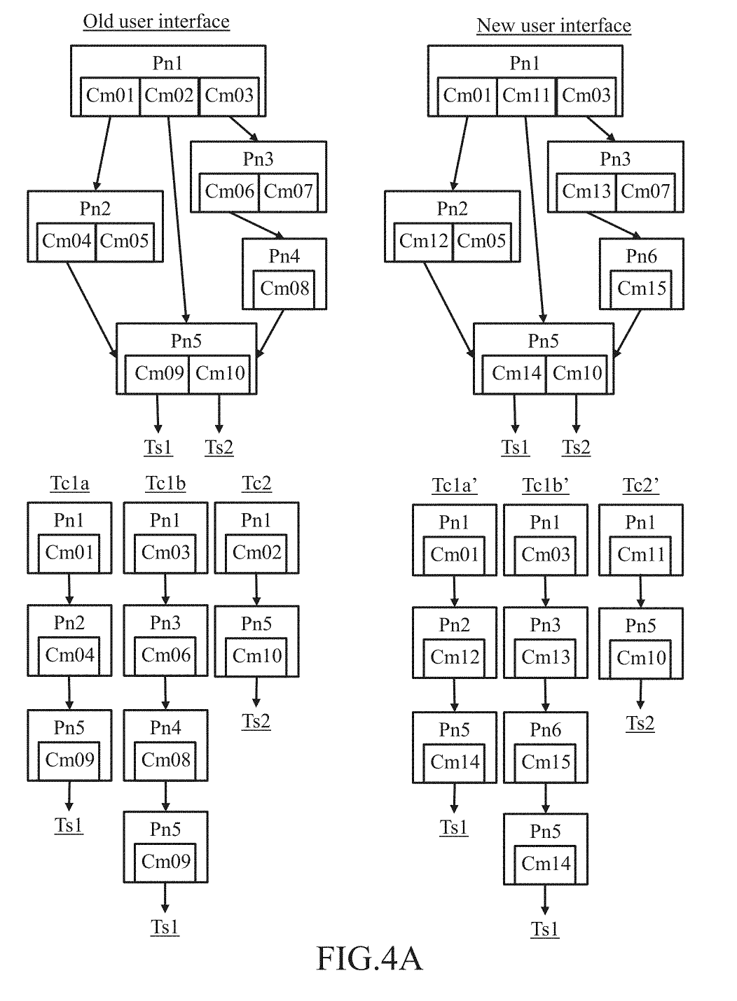

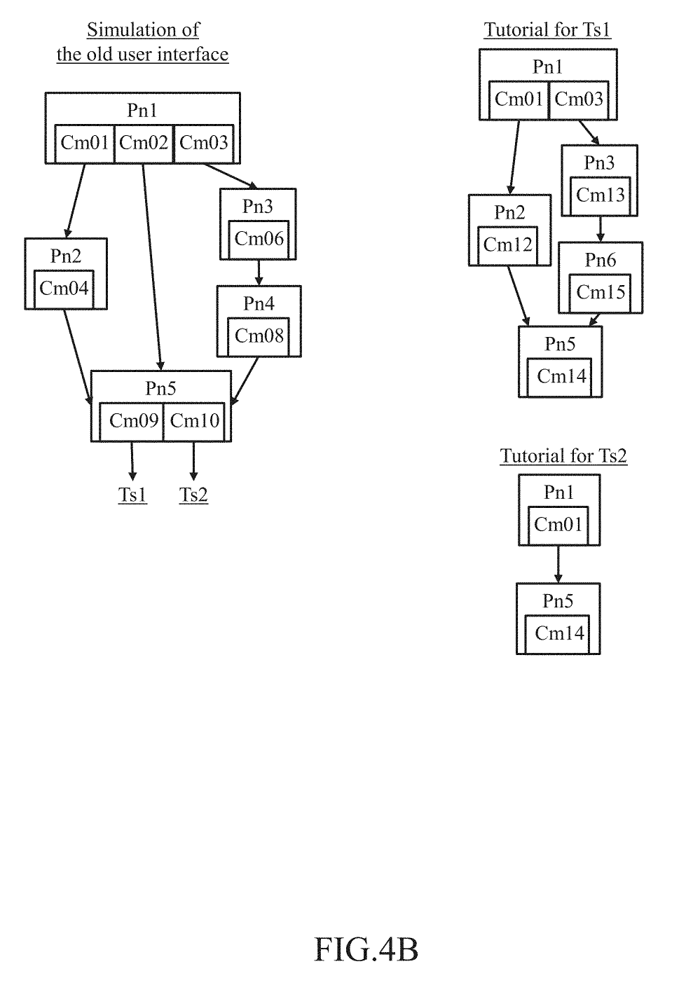

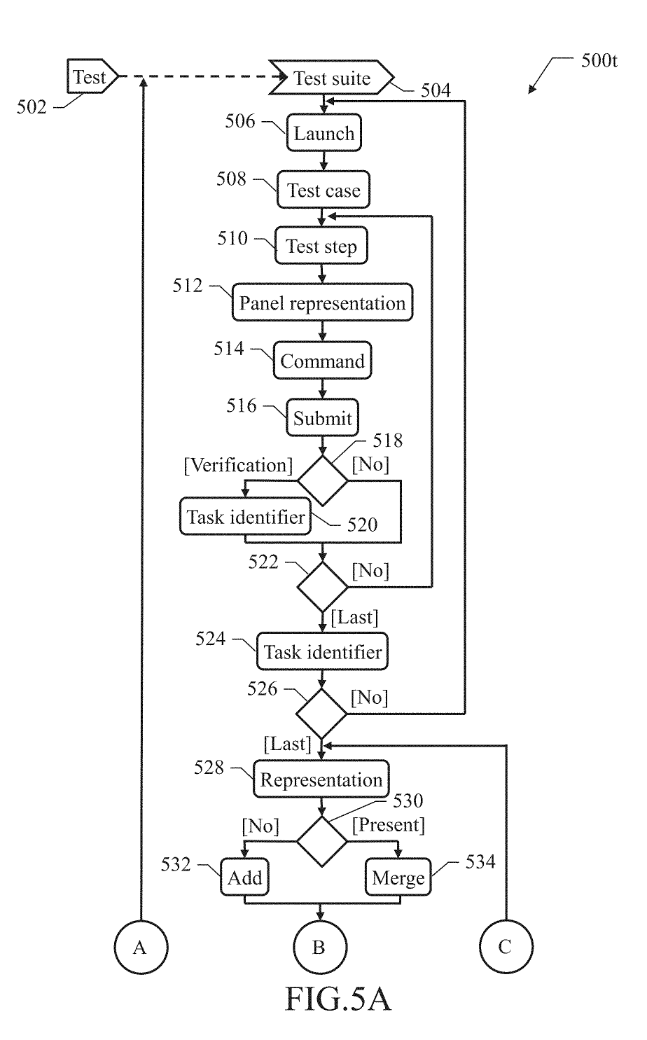

FIG. 4A is a block diagram of a scenario of an old interface and new interface of a software program, in accordance with embodiments of the present invention. FIG. 4B is a block diagram of a simulation of the old interface and tutorials, in accordance with embodiments of the present invention. Generally, each user interface of a generic software program comprises several panels; the panels are organized in a tree, starting from a root panel corresponding to a main entry point of the software program. Each panel contains one or more commands that may be submitted to the software program.

In a very simple scenario, an old version of the user interface (i.e. old user interface) comprises the following old panels with old commands: the panel Pn1 (i.e. root panel) containing the commands Cm01, Cm02 and Cm03, the panel Pn2 containing the commands Cm04 and Cm05, the panel Pn3 containing the commands Cm06 and Cm07, the panel Pn4 containing the command Cm08, and the panel Pn6 containing the commands Cm09 and Cm10; the command Cm01 leads to the panel Pn2, the command Cm02 leads to the panel Pn5, the command Cm03 leads to the panel Pn3, the command Cm04 leads to the panel Pn5, the command Cm06 leads to the panel Pn4, the command Cm08 leads to the panel Pn5, the command Cm09 executes a task Ts1 and the command Cm10 execute another task BT2, whereas the commands Cm05 and Cm07 are not relevant in this context. The new version of the same user interface (i.e. new user interface) instead comprises the following new panels with new commands: the same panel Pn1 (root panel) containing the command Cm11 instead of the command Cm02, the same panel Pn2 containing the command Cm12 instead of the command Cm04, the same panel Pn3 containing the command Cm13 instead of the command Cm06, the same panel Pn5 containing the command Cm14 instead of the command Cm09, and a panel Pn6 containing a command Cm15 instead of the panel Pn4; the command Cm11 leads to the panel Pn5, the command Cm12 leads to the panel Pn5, the command Cm13 leads to the panel Pn6 and the command Cm14 executes the task Ts1.

During the old test of the old user interface, the following old test cases are run to verify the tasks Ts1, Ts2: a test case Tc1a comprises submitting the commands Cm01, Cm04 and Cm09 in succession and then verifying the correct execution of the task Ts1, a test case Tc1bh comprises submitting the commands Cm03, Cm06, Cm08 and Cm09 in succession and then verifying the correct execution of the task Ts1 again, and a test case Tc2 comprises submitting the commands Cm02 and Cm10 in succession and then verifying the correct execution of the task Ts2. At the same time, the following panel representations are captured of the corresponding panels with their screenshots, commands and handlers: the panel Pn1 with the command Cm01, the panel Pn2 with the command Cm04 and the panel Pn5 with the command Cm09 for the task Ts1 (test case Tc1a), the panel Pn1 with the command Cm03, the panel Pn3 with the command Cm06, the panel Pn4 with the command Cm08 and the panel Pn5 with the command Cm09 for the task Ts1 (test case Tc1b), and the panel Pn1 with the command Cm02 and the panel Pn5 with the command Cm10 for the task Ts2 (test case Th2). The panel representations of the same panels are then merged with their commands and corresponding handlers. As a result, the simulation of the old user interface is obtained, comprising the panel Pn1 with the commands Cm01, Cm02 and Cm03, the panel Pn2 with the command Cm04, the panel Pn3 with the command Cm06, the panel Pn4 with the command Cm08, and the panel Pn6 with the commands Cm09 and Cm10.

During the new test of the new user interface, the following corresponding new test cases are run to verify the same tasks Ts1, Ts2: a test case Tc1a′ comprises submitting the commands Cm01, Cm12 and Cm14 in succession and then verifying the correct execution of the task Ts1, a test case c1b′ comprises submitting the commands Cm03, Cm13, Cm15 and Cm14 in succession and then verifying the correct execution of the task Ts1 again, and a test case Tc2′ comprises submitting the commands Cm11 and Cm10 in succession and then verifying the correct execution of the task Ts2. At the same time, the following tutorials are generated: a tutorial starts from the panel Pn1 and indicates the submission of the commands Cm01, Cm12 and Cm14 for executing the task Ts1 (test case Tc1a′), a tutorial starts from the panel Pn1 and indicates the submission of the commands Cm03, Cm13, Cm15 and Cm14 for executing the task Ts1 again (test case Tc1b), and a tutorial starts from the panel Pn1 and indicates the submission of the commands Cm11 and Cm10 for executing the task Ts2 (test case Tc2′). The tutorials of the same tasks are then merged. As a result, the guide of the new user interface is obtained, comprising the tutorial for the task Ts1 starting from the panel Pn1, indicating the submission of the command Cm01 or the command Cm03, and then the submission of the commands Cm12,Cm14 or the commands Cm13,Cm15,Cm14, respectively, and the tutorial for the task Ts2 starting from the panel Pn1 and indicating the submission of the commands Cm11,Cm10.

The simulation of the old user interface and the tutorials of the new user interface may then be used by any user of the software program to learn the software program's new user interface. For example, the user currently in the panel Pn2 of the new user interface does not know how to request the execution of the task Ts1 because the user does not find the command Cm04 any longer. In this condition, if the user submits the learning command, the same panel Pn2 is displayed in the simulation of the old user interface. The user may then submit the commands Cm04 and Cm09 as usual in the simulation of the old user interface to request the execution of the task Ts1. In response thereto, the tutorial of the same task Ts1 is displayed, starting from the same panel Pn2 and explaining that the same result may be achieved in the new user interface by submitting the commands Cm12 and Cm14. Likewise, the user currently in the panel Pn6 of the new user interface again does not know how to request the execution of the task Ts1 because the user does not find the panel Pn4 any longer. In this condition, if the user submits the learning command, the closest panel Pn3 is displayed in the simulation of the old user interface. The user may then submit the commands Cm06, Cm08 and Cm09 as usual in the simulation of the old user interface to request the execution of the task Ts1. In response thereto, the tutorial of the same task Ts1 is displayed, starting from the same panel Pn3 and explaining that the same result may be achieved in the new user interface by submitting the commands Cm13, Cm15 and Cm14.

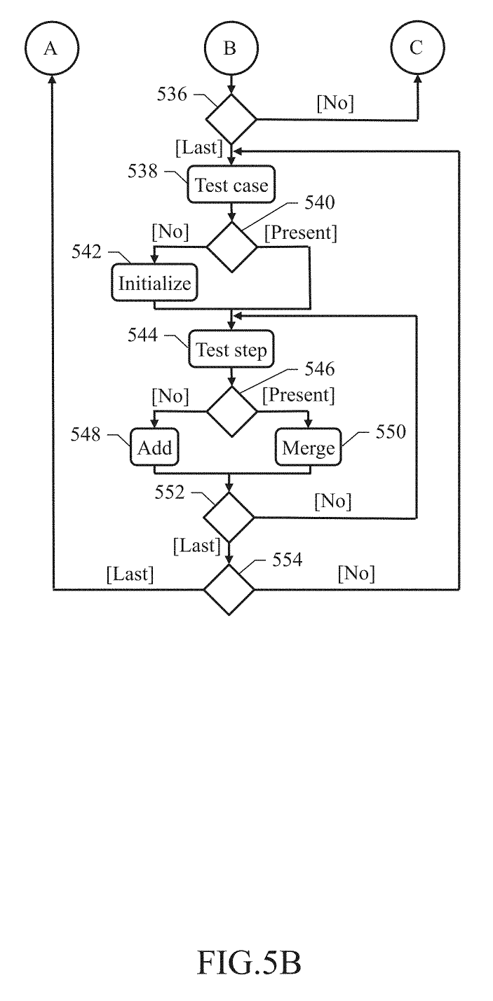

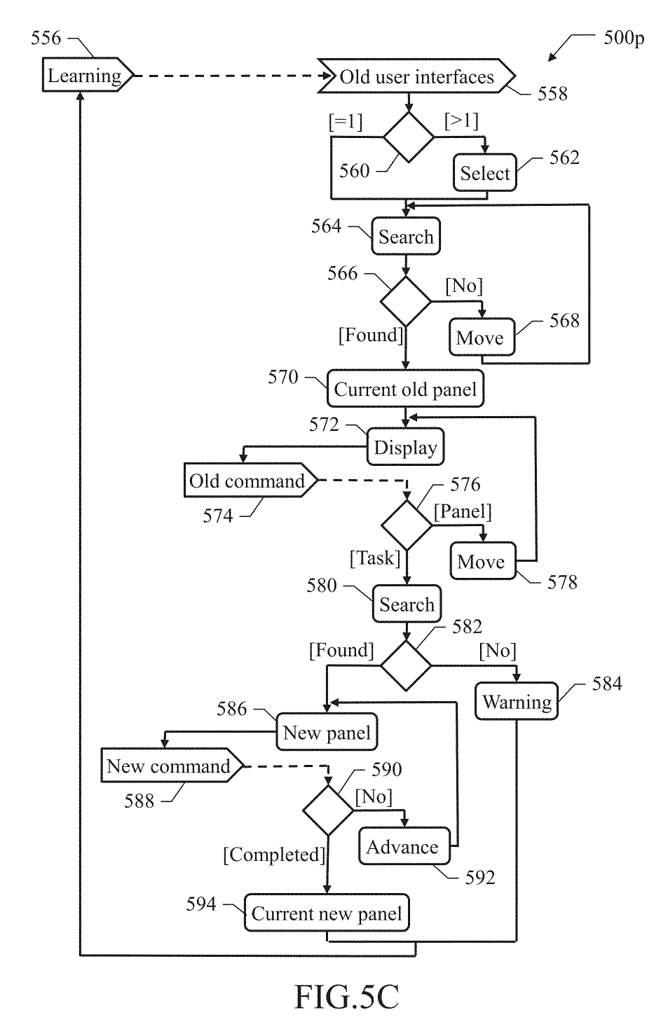

With reference now to FIG. 5A-FIG. 5C, an activity diagram is shown describing the flow of activities relating to an implementation of the solution according to an embodiment of the present disclosure. FIG. 5A is a first part of a flowchart of a method for building a software program in a test environment, in accordance with embodiments of the present invention. FIG. 5B is a second part of a flowchart of a method for building a software program in a test environment, in accordance with embodiments of the present invention.

Particularly, the diagram represents a possible implementation of the above-described solution. In this respect, each block may correspond to one or more executable instructions for implementing the specified logical function on the computer.

Particularly, a process that may be used to build a generic software program supporting the proposed solution (in its test environment) is represented with a method 500t.

The process passes from block 502 to block 504 as soon as a test of the software program is to be run (e.g., according to a corresponding test plan); in response thereto, the tester retrieves the corresponding test suite from the test suite repository. A loop is then entered for running the test cases of the test suite. The loop begins at block 506, wherein the tester launches the software program so as to display its root panel. Continuing to block 508, the tester takes a current test case into account starting from a first one in the test suite. A further loop is then entered for executing the test steps of the test case. The loop begins at block 510, wherein the tester takes a current test step into account starting from a first one in the test case. Continuing to block 512, the tester takes the screenshot of a current panel that is displayed on the monitor of the computer and saves the panel representation thereof in association with the corresponding panel identifier retrieved from the operating system and with a unique step identifier of the test step; at the same time apart from the beginning at the root panel the tester completes the panel representation of a previous panel by adding a handler for the command that has been submitted in the previous panel during the execution of a previous test step to move from the previous panel to the current panel, which handler indicates the current panel (i.e., a pointer to its panel identifier). Moreover, the tester at block 514 retrieves the command to be submitted to the software program with any possible input data from the action of the test step and the tester retrieves a position thereof in the current panel from the operating system; the tester then adds this information to the panel representation of the current panel. At this point, the tester at block 516 simulates the action of the test case as usual by submitting its command with the possible input data to the software program. The flow of activity then branches at block 518. If the test step comprises the verification of a task defined by the outcome of the task action, the tester at block 520 determines the result of the test step and adds the result to the test result repository as usual. At the same time, the tester generates the task identifier of the task according to this verification (e.g., formed by a string equal to a condition of the verification to be satisfied to pass the test); the tester then associates the task identifier with the panel representation of the current panel. The process now descends into block 522; the same point is also reached directly from the block 518 if the test step does not comprise any verification. At this point, the tester verifies whether a last test step has been processed. If not, the process returns to the block 510 to repeat the same operations for a next test step. Conversely, once all the test steps of the test case have been processed, the corresponding loop is exit by descending into block 524. As above, the tester determines the result of the task corresponding to the test case and adds the result to the test result repository as usual; at the same time, the tester completes the panel representation of the current panel by adding the handler for the command that has been submitted therein to request the execution of the task, which handler indicates this task (i.e., its task identifier). Continuing to block 526, the tester verifies whether a last test case has been processed. If not, the process returns to the block 506 to repeat the same operations for a next test case.

Conversely, once all the test cases of the test suite have been processed, the corresponding loop is exit by descending into block 528. At this point, a loop is entered for processing the panel representations in order to build the simulation of the user interface; the loop begins with the tester that takes a current panel representation into account starting from a first one in any arbitrary order. Continuing to block 530, the tester verifies whether the current panel representation is present in the simulation of the user interface empty at the beginning, (i.e., the latter comprises a pre-exiting panel representation associated with the same panel identifier of the current panel representation). If not, the tester at block 532 adds the current panel representation to the simulation of the user interface. Conversely, the tester at block 534 merges the current panel representation with the pre-existing panel representation in the simulation of the user interface; for this purpose, the indication of the command in the current panel representation and a handler of the command are added to the pre-existing panel representation. The flow of activity merges again at block 536 from either the block 532 or the block 534; at this point, the tester verifies whether a last panel representation has been processed. If not, the process returns to the block 528 to repeat the same operations for a next panel representation.

Conversely, once all the panel representations have been processed thereby completing the simulation of the user interface, the corresponding loop is exit by descending into 538. At this point, a loop is entered for processing the test cases in order to build the guide of the user interface; the loop begins with the tester that takes a current test case into account starting from a first one in any arbitrary order. Continuing to block 540, the tester verifies whether a tutorial for the task of the test case, as indicated by its task identifier, is present in the guide of the user interface empty at the beginning. If not, the tester at block 542 initializes a new tutorial for this task in the guide of the user interface. The flow of activity then continues to block 544, the same point is also reached directly from the block 540 if this tutorial is already present in the guide of the user interface. In both cases, a further loop is entered for processing the test steps of the test case; the loop begins with the tester that takes a current test step into account starting from a last one in the test case. Continuing to block 546, the tester verifies whether an explanation of the current panel relating to the action of the test step, as indicated by the tester's test step identifier associated therewith, is present in the tutorial empty at the beginning. If not, the tester at block 548 adds the explanation of the panel to the tutorial, i.e., the screenshot of the corresponding panel representation identified by the panel's panel identifier with instructions for submitting the corresponding command indicated in the test step. Conversely, the tester at block 550 merges the action of the test step to a pre-existing explanation of the panel in the tutorial; for this purpose, instructions for submitting the corresponding command indicated in the test step are added to the explanation of the panel, as an alternative to any other commands already indicated therein. The flow of activity merges again at block 552 from either the block 548 or the block 550; at this point, the tester verifies whether a last test step has been processed. If not, the process returns to the block 544 to repeat the same operations for a previous test step moving backward along the test case. Conversely, once all the test steps have been processed, the corresponding loop is exit by descending into block 554; at this point, the tester verifies whether a last test case has been processed. If not, the process returns to the block 538 to repeat the same operations for a next test case. Conversely, once all the test cases have been processed, thereby completing the guide of the user interface, the corresponding loop is exit by returning to the block 502, waiting for a next test of the software program.

FIG. 5C is a flowchart of a method for learning a new user interface of the software program in a production environment, in accordance with embodiments of the present invention. A process that may be used to learn the new user interface of the software program that is current available in the software program's production environment is instead represented with a method 500p.

The process passes from block 556 to block 558 as soon as a user of the software program submits the command corresponding to the learning request in a current new panel of the new user interface; in response thereto, the learning module retrieves the installed old user interfaces of the software program that have been installed on the computer in the past before the new user interface. The flow of activity then branches at block 560 according to the number of the installed old user interfaces (i.e. always at least one if the command for the learning request is disabled otherwise). If the number of the installed old user interfaces is higher than one, the learning module at block 562 displays a list thereof (e.g., in a pop-up window), prompting the user to selected one of them (e.g., with a slider). The process then descends into block 564; the same point is also reached directly from the block 560 if the number of the installed old user interfaces is one (e.g. with this installed old user interface that is selected automatically).

In both cases, the representation of an old panel equal to the current new panel is searched in the simulation of the old user interface that has been selected, either manually or automatically according to its panel identifier. The flow of activity then branches at block 566 according to a result of this search. If the representation of no old panel equal to the current new panel has been found, the learning module at block 568 moves the current new panel to the current new panel's parent new panel in the new tree (e.g. upwards towards the root new panel thereof). The process then returns to the block 564 to repeat the same search for the moved current new panel. Referring again to the block 566, as soon as the representation of an old panel equal to the current new panel has been found or the current new panel has reached the root new panel, the process descends into block 570; at this point, the learning module sets a current old panel equal to the current new panel.

Continuing to block 572, the learning module retrieves the panel representation of the current old panel from the simulation of the user interface; the learning module then displays the screenshot of the current old panel (e.g. not selectable) with the addition of the current old panel commands (e.g. selectable and possibly highlighted), according to definitions in the panel representation (e.g., by covering the current new panel on the monitor). In this way, the user is automatically brought to a condition in the simulation of the old user interface that is as closest as possible to the user condition in the new user interface. The process then enters a waiting condition at block 574 for the submission of a selected old command in the current old panel. As soon as this happens, the learning module at block 576 removes the display of the current old panel, with the flow of activity that then branches according to a type of the selected command. Particularly, if the handler of the selected command indicates the panel identifier of another old panel, the learning module at block 578 moves the current old panel to the old panel indicated in the handler; the process then returns to the block 572 to repeat the same operations for the moved current old panel.

Referring back to the block 576, as soon as the handler of the selected command indicates the task identifier of a selected task which the user wants to know how to perform in the new user interface, the process descends to block 580; at this point, the learning module searches the corresponding tutorial in the guide of the new user interface according to the task identifier. The flow of activity then branches at block 582 according to a result of this search. If no tutorial has been found for the selected task, the learning module outputs a corresponding warning (e.g., informing the user that the selected task has been removed in the new user interface). The process then returns to the block 556, waiting for a next learning request. Referring back to the block 582, if a selected tutorial for the selected task has been found, the learning module at block 586 extracts the explanation of a learning new panel equal to the current old panel (i.e., the current new panel) from the tutorial or equal to the closest old panel moving upwards in the old tree; the learning module then displays the explanation of the learning new panel, i.e., the screenshot of the learning new panel (e.g. not selectable) with the addition of its commands (e.g. selectable and possibly highlighted) and the corresponding instructions (e.g., again by covering the current new panel on the monitor). In this way, the tutorial is limited to a portion thereof that is likely to be of interest for the user according to the actual condition in the new user interface. The process then enters a waiting condition at block 588 for the submission of a selected new command in the learning new panel following the corresponding instructions, for example, displayed in a label close to each new command. As soon as this happens, the learning module at block 590 removes the display of the explanation of the learning new panel, with the flow of activity that then branches according to a point that has been reached in the tutorial. Particularly, if the tutorial has not been completed yet, the learning module at block 592 advances the learning new panel to a next one in the tutorial corresponding to the selected new command; the process then returns to the block 586 to repeat the same operations for the advanced learning new panel. Referring back to the block 590, as soon as the tutorial has been completed the process descends into block 594; at this point, the learning module displays the new user interface with the moved current new panel. In this way, the user is automatically brought to the best position for actually submitting the new commands indicated in the tutorial for requesting the execution of the selected task in the new user interface. The process then returns to the block 556, waiting for a next learning request.

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may even be practiced without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. In any case, each numerical value should be read as modified by the term about (unless already done) and each range of numerical values should be intended as expressly specifying any possible number along the continuum within the range (comprising the range's end points). Moreover, ordinal or other qualifiers are merely used as labels to distinguish elements with the same name but do not by themselves connote any priority, precedence or order. The terms include, comprise, have, contain and involve (and any forms thereof) should be intended with an open, non-exhaustive meaning (i.e., not limited to the recited items), the terms based on, dependent on, according to, function of (and any forms thereof) should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a method for facilitating usage of a software program in a computing system. However, the software program may be of any type (e.g., any application program like an office suite, an e-mail client, a graphic tool, a middleware program like a development environment, a database manager, an operative system) running on any computing system (see below).

In an embodiment, the software program has a new user interface that exposes one or more new commands for requesting execution of one or more tasks to the software program. However, the user interface may be of any type (e.g., a GUI, a Command Line Interface, or CLI), which may expose any number and type of commands (e.g., buttons, menus, gestures, instructions) for requesting the execution of any number and type of tasks (e.g., verifying a document, archiving an e-mail, drawing a geometrical shape, compiling a program, running a query, managing user authorizations).

In an embodiment, the method comprises receiving a learning request in the new user interface. However, the learning request may be submitted in any way (e.g., with a command, an instruction, a combination of keys).

In an embodiment, the method comprises displaying a simulation of an old user interface of the software program in response to the learning request. However, the old user interface may be of any type (e.g., another older and/or newer version of the user interface, a version of the user interface for a different hardware and/or software framework like personal computer, smartphone, operating system, vendor); moreover, the simulation may be provided in any way (e.g., stored locally or downloaded from the communication network).

In an embodiment, the simulation of the old user interface exposes one or more old commands for requesting the execution of said tasks. However, the old commands may be in any number and of any type (e.g. either the same or different with respect to the new commands, for example, with different, additional or alternative commands) and the old commands may be exposed in any way in the simulation of the old user interface (e.g., overlaid to screenshots, alone, simply listed).

In an embodiment, the method comprises receiving a submission of one or more selected old commands of the old commands in the simulation of the old user interface for requesting the execution of a selected task of the tasks. However, the selected old commands may be in any number and they may be submitted in any way (e.g., clicking or typing).

In an embodiment, the method comprises identifying a selected tutorial for the selected task among one or more corresponding tutorials for the tasks in response to the submission of the selected old commands. However, the tutorials may be in any number, the tutorials may be provided in any way (e.g., stored locally or downloaded from the communication network) and the selected tutorial may be identified among them in any way (e.g., according to the selected task only or according to a corresponding starting point as well).

In an embodiment, each tutorial comprises an indication of one or more selected new commands of said new commands for requesting the execution of the corresponding task in the new user interface. However, the tutorials may be of any type (e.g., pictures, video, text, audio or any combination thereof).

In an embodiment, the method comprises outputting a representation of the selected tutorial. However, the representation of the selected tutorial may be output in any way (e.g., displayed, printed and/or uttered, passively or interactively, progressing automatically or in response to corresponding commands).

In an embodiment, the method comprises receiving the learning request in a current new condition of the new user interface. However, the current new condition may be of any type (e.g., defined by state variables).

In an embodiment, the method comprises displaying the simulation of the old user interface starting from a current old condition corresponding to the current new condition. However, the current old condition may be determined in any way (e.g., the most similar one): in any case, the possibility of displaying the simulation of the old user interface always starting from a same condition is not excluded (e.g., at an entry point of the software program).

In an embodiment, the method comprises outputting the representation of the selected tutorial starting from a learning new condition in the new user interface corresponding to the current old condition. However, the learning new condition may be determined in any way (e.g. either the same or different with respect to the determination of the current old condition); in any case, the possibility of outputting the selected tutorial always starting from a same condition is not excluded (e.g., again at an entry point of the software program).

In an embodiment, the method comprises displaying the new user interface in the new condition in response to a completion of the selected tutorial. However, different, additional or alternative operations may be performed after the completion of the selected tutorial (e.g., returning the new user interface to its current condition before the learning request, executing the new commands automatically therein).

In an embodiment, the new user interface comprises a plurality of new containers for the new commands organized in a new tree starting from a root new container of the new containers. However, the new containers may be in any number and of any type (e.g., panels, windows, panes); in any case, the possibility is not excluded of having the new containers organized in a different way (e.g., in a cyclic graph) or even missing at all.

In an embodiment, the simulation of the old user interface comprises a plurality of old containers for the old commands organized in an old tree starting from a root old container of the old containers equal to the root new container. However, the old containers may be in any number and of any type, and they may be organized in another way (e.g. either the same or different with respect to the new containers) or missing at all.

In an embodiment, the method comprises receiving the learning request in a current new container of the new containers. However, the learning request may also be submitted in a different condition (e.g., in a command line).

In an embodiment, the method comprises displaying a representation of a current old container of the old containers in response to the learning request, with the current old container that is equal to the current new container or to a parent new container of said new containers closest to the current new container moving therefrom to the root new container in the new tree. However, the current old container may be determined in any way, even always the same (e.g., the root old container).

In an embodiment, the method comprises outputting the representation of the selected tutorial starting from a learning new container of the new containers, with the learning new container that is equal to the current old container or to a parent old container of the old containers closest to the current old container moving therefrom to the root old container in the old tree. However, the learning new container may be determined in any way, even always the same (e.g., the root new container).

In an embodiment, the method comprises displaying the new user interface at the learning new container in response to a completion of the selected tutorial. However, different, additional or alternative operations may be performed after the completion of the selected tutorial (e.g., returning to the current new container before the learning request).

In an embodiment, the method comprises retrieving an indication of one or more installed old user interfaces of the software program, which have been installed on the computing system before the new user interface. However, the installed old user interfaces may be in any number and they may be determined in any way (e.g., read from a configuration file of the software application).

In an embodiment, the method comprises receiving a selection of the old user interface among the delivered old user interfaces. However, the selection of the old user interface may be performed in any way (e.g., by selecting a date and then finding the old user interface that was installed at that date); in any case, the possibility is not excluded of selecting the old user interface among all the available user interfaces of the software program (e.g. irrespectively of their installation on the computing system) or of always setting the user interface automatically to the most recent one.

In an embodiment, the method comprises running an old test of the software program having the old user interface. However, the old test may be run in any way (e.g., building the simulation and the guide only when the old user interface has completely passed).

In an embodiment, the old test comprises one or more old test cases each comprising the submission of one or more test old commands of the old commands requesting the execution of an old test task of the tasks to the software program and an old verification of the old test task. However, the old test may comprise any number and type of old test cases (e.g., for verifying correctness or performance of the software program), each comprising the submission of any number of test old commands for any number of old test tasks (e.g., only at the end of the old test case or during the old test as well); moreover, each old test case may comprise any number and type of old verifications (e.g., verifying one or more conditions based on obtained results, execution time).

In an embodiment, the method comprises capturing corresponding old representations of the old user interface for the submission of the test old commands. However, each old representation may be of any type (e.g., a screenshot, a simple indication of the old panel and the panel's old test command).

In an embodiment, the method comprises adding the old representations to the simulation of the old user interface. However, the old representations may be added in any way (e.g., only for some of the old test cases selected in any way, like with flags, or for all of the old test cases).

In an embodiment, the method comprises merging any old representations relating to common conditions of the old user interface. However, the old representations may be merged in any way and for any common condition (e.g., with a common handler for all commands, only for panels exactly the same); in any case, the possibility of building the simulation of the old user interface without merging the old representations is not excluded.

In an embodiment, the method comprises running a new test of the software program having the new user interface. However, the new test may be run in any way (e.g. either the same or different with respect of the old test, at the same time or separately).

In an embodiment, the new test comprises one or more new test cases each comprising the submission of one or more test new commands of the new commands requesting the execution of a new test task of the tasks to the software program and a new verification of the new test task. However, the new test may comprise any number and type of new test cases, each comprising any number of test new commands for any number of new test tasks with any number and type of new verifications (e.g. either the same or different with respect to the old test).

In an embodiment, the method comprises building one of the tutorials for each new test task according to the test new commands requesting the execution of the new test task. However, each tutorial may be built in any way (e.g., only for some of the new test cases selected in any way, like with flags, or for all of new test cases indiscriminately).

In an embodiment, the method comprises merging any tutorials of common new test tasks. However, the tutorials may be merged in any way and in any conditions (example.g., for similar new test tasks); in any case, the possibility of building the guide of the new user interface without merging its tutorials is not excluded.

In an embodiment, the method comprises associating corresponding task identifiers with the old test tasks in the simulation of the old user interface, with the task identifier of each old test task that is generated from the corresponding old verification. However, each task identifier may be generated in any way, even independently of the corresponding old verification (e.g., according to state variables of the software program).

In an embodiment, the method comprises associating corresponding task identifiers with the new test tasks in the tutorials, with the task identifier of each new test task that is generated from the corresponding new verification. However, in this case as well each task identifier may be generated in any way as above.

In an embodiment, the method comprises identifying the selected tutorial associated with the task identifier of the selected task in response to the submission of the selected old commands. However, the task identifiers may be associated with the tutorials and the selected old commands in any way (e.g., in a dedicated lookup table).

In an embodiment, the method comprises generating each task identifier according to a string based on one or more conditions of the corresponding old verification or new verification. However, each task identifier may be generated in any way, according to any number and type of the corresponding conditions (e.g., by sorting multiple conditions and then concatenating the conditions, by an equivalent string in canonical form).

An embodiment provides a method for building a computer program configured for causing a computing system to perform the above-mentioned method when the computer program is executed on the computing system. Particularly, an embodiment provides a method for building a computer program for facilitating usage of a software program, the method comprising: running an old test of the software program having an old user interface exposing one or more old commands for requesting execution of one or more tasks to the software program, the old test comprising one or more old test cases each comprising the submission of one or more test old commands of said old commands requesting the execution of an old test task of the tasks to the software program and an old verification of the old test task, capturing corresponding old representations of the old user interface for the submission of the test old commands, adding the old representations to a simulation of the old user interface, running a new test of the software program having a new user interface exposing one or more new commands for requesting the execution of the tasks to the software program, the new test comprising one or more new test cases each comprising the submission of one or more test new commands of said new commands requesting the execution of a new test task of said tasks to the software program and a new verification of the new test task, and building corresponding one or more tutorials for the new test tasks each according to the test new commands requesting the execution of the new test task.

Similar considerations as above apply to this method and to any possible additional features thereof.

Generally, similar considerations apply if the same solution is implemented with an equivalent method (e.g. by using similar steps with the same functions of more steps or portions thereof, removing some steps being non-essential, or adding further optional steps); moreover, the steps may be performed in a different order, concurrently or in an interleaved way (e.g. at least in part).

An embodiment provides a computer program configured for causing a computing system to perform each of the above-mentioned methods when the computer program is executed on the computing system. An embodiment provides a computer program product, the computer program product comprising a computer readable storage medium having program instructions embodied therewith, the program instructions being executable by a computing system to cause the computing system to perform each of the same methods. However, the software program may be implemented as a stand-alone module, as a plug-in for a pre-existing software program (e.g., the software program or the tester, respectively), or even directly in the software program; moreover, the software program may run on any computing system (see below). In any case, the solution according to an embodiment of the present disclosure lends itself to be implemented even with a hardware structure (e.g., by electronic circuits integrated in one or more chips of semiconductor material), or with a combination of software and hardware suitably programmed or otherwise configured.

An embodiment provides a system comprising means configured for performing each of the steps of each of the above-mentioned methods. An embodiment provides a system comprising a circuitry (i.e., any hardware suitably configured, for example, by software) configured for performing each of the steps of each of the same methods. However, the system may be of any type, either the same or different between the test environment and the production environment (for example, a physical and/or a virtual computing machine, a distributed architecture based on a local, wide area, global, cellular or satellite network and exploiting any type of wired and/or wireless connections).

Generally, similar considerations apply if the system has a different structure or comprises equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interactivity between different components generally does not need to be continuous, and it may be either direct or indirect through one or more intermediaries.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In one embodiment, the system of the present invention may be or include a hardware device such as a computer, portable device, etc. In one embodiment, the hardware device is or includes a special-purpose device (e.g., computer, machine, portable device) that comprises specialized, non-generic hardware and circuitry (i.e., specialized discrete non-generic analog, digital, and logic based circuitry) for (independently or in combination) particularized for executing only methods of the present invention. The specialized discrete non-generic analog, digital, and logic based circuitry may include proprietary specially designed components (e.g., a specialized integrated circuit, such as for example an Application Specific Integrated Circuit (ASIC), designed for only implementing methods of the present invention).

A computer program product of the present invention may include one or more computer readable hardware storage devices having computer readable program code stored therein, said program code containing instructions executable by one or more processors of a computing system (or computer system) to implement the methods of the present invention.

A computer system of the present invention may include one or more processors, one or more memories, and one or more computer readable hardware storage devices, said one or more hardware storage devices containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A method for facilitating usage of a software program on a computing system, the software program having a new user interface exposing one or more new commands for requesting execution of one or more tasks to the software program, wherein the method comprises:
receiving, by a processor of the computing system, a learning request in the new user interface;
displaying, by the processor, a simulation of an old user interface of the software program in response to the learning request, the simulation of the old user interface exposing one or more old commands for requesting the execution of the one or more tasks;
receiving, by a processor, a submission of one or more selected old commands of the one or more old commands in the simulation of the old user interface for requesting the execution of a selected task of the one or more tasks;
identifying, by the processor, a selected tutorial for the selected task among one or more corresponding tutorials for the one or more tasks in response to the submission of the selected old commands, each tutorial comprising an indication of one or more selected new commands of the one or more new commands for requesting the execution of the corresponding task in the new user interface; and
outputting, by the processor, a representation of the selected tutorial.

2. The method according to claim 1, further comprising:
receiving, by the processor, the learning request in a current new condition of the new user interface; and
displaying, by the processor, the simulation of the old user interface starting from a current old condition corresponding to the current new condition.

3. The method according to claim 2, further comprising:
outputting, by the processor, the representation of the selected tutorial starting from a learning new condition in the new user interface corresponding to the current old condition.

4. The method according to claim 2, further comprising:
displaying, by the processor, the new user interface in the learning new condition in response to a completion of the selected tutorial.

5. The method according to claim 1, wherein the new user interface comprises a plurality of new containers for the new commands organized in a new tree starting from a root new container of the new containers and the simulation of the old user interface comprises a plurality of old containers for the old commands organized in an old tree starting from a root old container of the old containers equal to the root new container, the method comprising:
receiving, by the processor, the learning request in a current new container of said new containers;
displaying, by the processor, a representation of a current old container of said old containers in response to the learning request, the current old container being equal to the current new container or to a parent new container of said new containers closest to the current new container moving therefrom to the root new container in the new tree;
outputting, by the processor, the representation of the selected tutorial starting from a learning new container of said new containers, the leaning new container being equal to the current old container or to a parent old container of said old containers closest to the current old container moving therefrom to the root old container in the old tree; and
displaying, by the processor, the new user interface at the learning new container in response to a completion of the selected tutorial.

6. The method according to claim 1, further comprising:
retrieving, by the processor, an indication of one or more installed old user interfaces of the software program having been installed on the computing system before the new user interface; and
receiving, by the processor, a selection of the old user interface among the delivered old user interfaces.

7. The method according to claim 1, further comprising:
running, by the processor, an old test of the software program having the old user interface, the old test comprising one or more old test cases each comprising the submission of one or more test old commands of said old commands requesting the execution of an old test task of said tasks to the software program and an old verification of the old test task;
capturing, by the processor, corresponding old representations of the old user interface for the submission of the test old commands; and
adding, by the processor, the old representations to the simulation of the old user interface.

8. The method according to claim 7, further comprising:
merging, by the processor, any old representations relating to common conditions of the old user interface.

9. The method according to claim 7, further comprising:
running, by the processor, a new test of the software program having the new user interface, the new test comprising one or more new test cases each comprising the submission of one or more test new commands of said new commands requesting the execution of a new test task of said tasks to the software program and a new verification of the new test task; and
building, by the processor, one of the tutorials for each new test task according to the test new commands requesting the execution of the new test task.

10. The method according to claim 9, further comprising:
merging, by the processor, any tutorials of common new test tasks.

11. The method according to claim 9, further comprising:
associating, by the processor, corresponding task identifiers with the old test tasks in the simulation of the old user interface, the task identifier of each old test task being generated from the corresponding old verification;
associating, by the processor, corresponding task identifiers with the new test tasks in the tutorials, the task identifier of each new test task being generated from the corresponding new verification; and
identifying, by the processor, the selected tutorial associated with the task identifier of the selected task in response to the submission of the selected old commands.

12. The method according to claim 11, further comprising:
generating, by the processor, each task identifier according to a string based on one or more conditions of the corresponding old verification or new verification.

13. A computer program product, comprising a computer readable hardware storage device storing a computer readable program code, the computer readable program code comprising an algorithm that when executed by a computer processor of a computing system implements a method for facilitating usage of a software program on a computing system, the method comprising receiving, by a processor of the computing system, a learning request in the new user interface;
displaying, by the processor, a simulation of an old user interface of the software program in response to the learning request, the simulation of the old user interface exposing one or more old commands for requesting the execution of the one or more tasks;
receiving, by a processor, a submission of one or more selected old commands of the one or more old commands in the simulation of the old user interface for requesting the execution of a selected task of the one or more tasks;
identifying, by the processor, a selected tutorial for the selected task among one or more corresponding tutorials for the one or more tasks in response to the submission of the selected old commands, each tutorial comprising an indication of one or more selected new commands of the one or more new commands for requesting the execution of the corresponding task in the new user interface; and
outputting, by the processor, a representation of the selected tutorial.

14. A computer system comprising:
a processor;
a memory device coupled to the processor; and
a computer readable storage device coupled to the processor, wherein the storage device contains program code executable by the processor via the memory device to implement a method for facilitating usage of a software program on a computing system, the method comprising:
receiving, by a processor of the computing system, a learning request in the new user interface;
displaying, by the processor, a simulation of an old user interface of the software program in response to the learning request, the simulation of the old user interface exposing one or more old commands for requesting the execution of the one or more tasks;
receiving, by a processor, a submission of one or more selected old commands of the one or more old commands in the simulation of the old user interface for requesting the execution of a selected task of the one or more tasks;
identifying, by the processor, a selected tutorial for the selected task among one or more corresponding tutorials for the one or more tasks in response to the submission of the selected old commands, each tutorial comprising an indication of one or more selected new commands of the one or more new commands for requesting the execution of the corresponding task in the new user interface; and
outputting, by the processor, a representation of the selected tutorial.
